(19) United States
(12) Patent Application Publication
(10) Pub. No.: US 2012/0062478 A1
(43) Pub. Date: Mar. 15, 2012

(54) TOUCH PANEL

(75) Inventors: Woon Chun Kim, Gyunggi-do (KR); Yong Soo Oh, Gyunggi-do (KR); Hyun Jun Kim, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/960,254

(22) Filed: Dec. 3, 2010

(30) Foreign Application Priority Data
Sep. 9, 2010 (KR) 1020100088218

(51) Int. Cl. G06F 3/041

(52) U.S. Cl. 345/173

(57) ABSTRACT

Disclosed herein is a touch panel. The touch panel according to the present invention includes a first adhesive layer bonding an edge of an image display device to an edge of a window so that a predetermined space is partitioned between the image display device and the window; a first transparent substrate provided in the predetermined space and having a first transparent electrode formed on one surface thereof, a second transparent substrate provided in the predetermined space and having a second transparent electrode formed on one surface thereof, and a second adhesive layer bonding an edge of the first transparent electrode to an edge of the second transparent electrode so that the first transparent electrode faces the second transparent electrode and an air gap is provided between the first transparent electrode and the second transparent electrode.

### CROSS REFERENCE TO RELATED APPLICATION

This application claims the benefit of Korean Patent Application No. 10-2010-0088218, filed on Sep. 9, 2010, entitled “Touch Panel”, which is hereby incorporated by reference in its entirety into this application.

### BACKGROUND OF THE INVENTION

1. Technical Field

The present invention relates to a touch panel.

2. Description of the Related Art

Alongside the growth of computers using digital technology, devices assisting computers have also been developed, and personal computers, portable transmitters and other personal information processors execute processing of text and graphics using a variety of input devices such as a keyboard and a mouse.

While the rapid advancement of the information-based society has been widening the use of computers more and more, there have been occurring the problems of it being difficult to efficiently operate products using only the keyboard and mouse as being currently responsible for the input device function. Thus, the demand for a device that is simple, has minimum malfunction, and has the capability to easily input information is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, resistive and capacitive types are prevalently used in a broad range of fields currently.

However, the touch panel according to the prior art has problems in bonding an image display device. FIG. 1 is a cross-sectional view of a touch panel according to the prior art. Problems of the prior art will be described with reference to FIG. 1.

As shown in FIG. 1, a first transparent substrate 10 on which a first transparent electrode 15 is formed is bonded to a second transparent substrate 20 on which a second transparent electrode 25 is formed by a first adhesive layer 30, a top surface of the first transparent substrate 10 is bonded to a window 40 by an optical clear adhesive 45, and a bottom surface of the second transparent substrate 20 is bonded to an image display device 60 by a second adhesive layer 50. Therefore, an empty space 55 is provided between the second transparent substrate 20 and the image display device 60, such that Newton's rings are generated when the window 40 is touched by a user and visibility is degraded accordingly. In addition, an entire thickness of the touch panel becomes thick due to a thickness of the second adhesive layer 50 itself bonding the bottom surface of the second transparent substrate 20 to the image display device 60. In addition, only the first adhesive layer 30 serves to block the first transparent electrode 15 and the second transparent electrode 25 from the outside of the touch panel, such that the first transparent electrode 15 and the second transparent electrode 25 may be highly damaged due to the infiltration of moisture and oil.

### SUMMARY OF THE INVENTION

The present invention has been made in an effort to provide a touch panel that bonds an image display device to a window by an adhesive layer so that a predetermined space is partitioned between the image display device and the window and disposes transparent substrates on which transparent electrodes are formed in the predetermined space, thereby making it possible to prevent Newton's rings from occurring, implement a thin thickness, and prevent infiltration of moisture or oil.

A touch panel according to a first preferred embodiment of the present invention includes: a first adhesive layer bonding an edge of an image display device to an edge of a window so that a predetermined space is partitioned between the image display device and the window; a first transparent substrate provided in the predetermined space and having a first transparent electrode formed on one surface thereof; a second transparent substrate provided in the predetermined space and having a second transparent electrode formed on one surface thereof; and a second adhesive layer bonding an edge of the first transparent electrode to an edge of the second transparent electrode so that the first transparent electrode faces the second transparent electrode and an air gap is provided between the first transparent electrode and the second transparent electrode.

Herein, the touch panel further includes a third adhesive layer bonding the other surface of the first transparent substrate to the window.

A side surface of the first transparent substrate and a side surface of the second transparent substrate are in contact with an inner side surface of the first adhesive layer.

The touch panel further includes a first electrode wiring formed at the edge of the first transparent electrode; and a second electrode wiring formed at the edge of the second transparent electrode.

The first electrode wiring is formed to be closer to the first adhesive layer as compared to the second electrode wiring.

The second electrode wiring is formed to be closer to the first adhesive layer as compared to the first electrode wiring.

Dot spacers are provided on the first transparent electrode or the second transparent electrode.

The first adhesive layer is a double adhesive tape (DAT)

The second adhesive layer is a double adhesive tape (DAT).

The third adhesive layer is an optical clear adhesive (OCA).

A touch panel according to a second preferred embodiment of the present invention includes: a first adhesive layer bonding an edge of an image display device to an edge of a window so that a predetermined space is partitioned between the image display device and the window; a first transparent substrate provided in the predetermined space and having a first transparent electrode formed on one surface thereof; a second transparent substrate provided in the predetermined space and having a second transparent electrode formed on one surface thereof; and a second adhesive layer bonding the first transparent substrate to the second transparent substrate so that the first transparent electrode is insulated from the second transparent electrode, while the first transparent electrode and the second transparent electrode are facing each other.

The touch panel includes a third adhesive layer bonding the other surface of the first transparent substrate to the window.

A side surface of the first transparent substrate and a side surface of the second transparent substrate are in contact with an inner side surface of the first adhesive layer.

The touch panel further includes a first electrode wiring formed at the edge of the first transparent electrode; and a second electrode wiring formed at the edge of the second transparent electrode.

The first electrode wiring is formed to be closer to the first adhesive layer as compared to the second electrode wiring.

The second electrode wiring is formed to be closer to the first adhesive layer as compared to the first electrode wiring.

The first adhesive layer is a double adhesive tape (DAT).

The second adhesive layer is an optical clear adhesive (OCA).

The third adhesive layer is an optical clear adhesive (OCA).

### BRIEF DESCRIPTION OF THE DRAWINGS

FIG. 1 is a cross-sectional view of a touch panel according to the prior art;

FIGS. 2 to 4 are cross-sectional views of a touch panel according to a first preferred embodiment of the present invention; and

FIGS. 5 to 7 are cross-sectional views of a touch panel according to a second preferred embodiment of the present invention.

### DESCRIPTION OF THE PREFERRED EMBODIMENTS

Various features and advantages of the present invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Terms used in the specification, ‘first’, ‘second’, etc. can be used to describe various components, but the components are not to be construed as being limited to the terms. The terms are only used to differentiate one component from other components. Further, in describing the present invention, a detailed description of related known functions or configurations will be omitted so as not to obscure the subject of the present invention.

Hereinafter, preferred embodiments of the present invention will be described in detail with reference to the accompanying drawings.

FIGS. 2 to 4 are cross-sectional views of a touch panel according to a first preferred embodiment of the present invention.

Referring to FIGS. 2 to 4, a touch panel 100 according to the present invention includes a first adhesive layer 130 bonding an edge of an image display device 110 to an edge of a window 120 so that a predetermined space 125 is partitioned between the image display device 110 and the window 120, a first transparent substrate 140 provided in the predetermined space 125 and having a first transparent electrode 145 formed on one surface thereof, a second transparent substrate 150 provided in the predetermined space 125 and having a second transparent electrode 155 formed on one surface thereof, and a second adhesive layer 160 bonding an edge of the first transparent electrode 145 to an edge of the second transparent electrode 155 so that the first transparent electrode 145 faces the second transparent electrode 155 and an air gap 165 is provided between the first transparent electrode 145 and the second transparent electrode 155.

The image display device 110, which serves to output an image, includes a liquid crystal display (LCD) device, a plasma display panel (PDP), an electroluminescence (EL), a cathode ray tube (CRT) or the like. The window 120 is provided at the outermost portion of the touch panel 100 to protect the touch panel 100. The window 120 may be made of glass, tempered glass or the like but is not always limited thereto. Meanwhile, various functional layers such as an anti-finger (AF) layer, an anti-glare (AG) or anti-reflection (AR) layer, or the like may be provided on a top surface of the window.

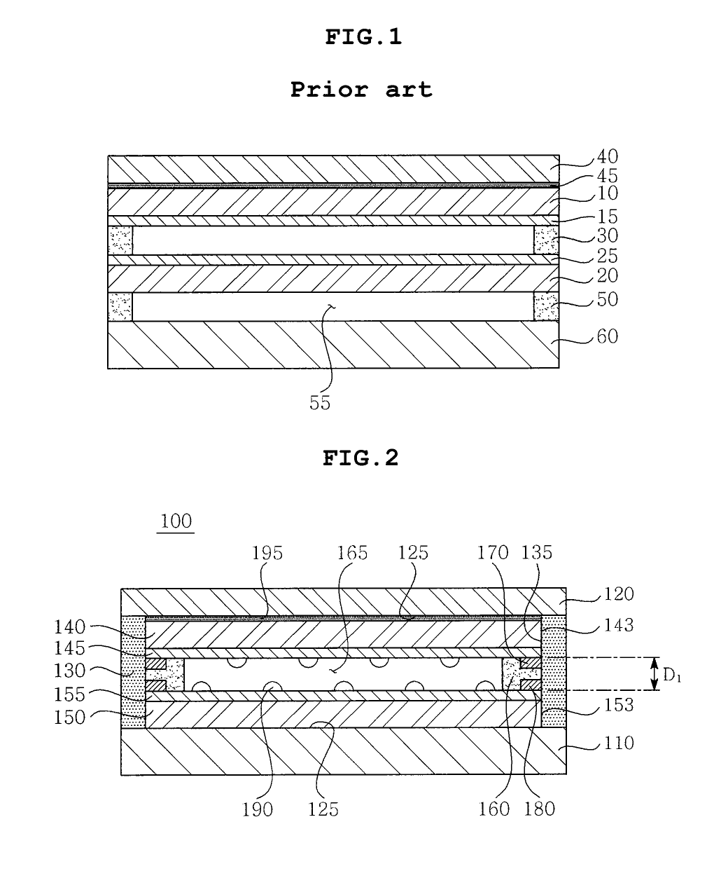

The first adhesive layer 130 serves to bond the image display device 110 to the window 120. Herein, the first adhesive layer 130 bonds the edge of the image display device 110 to the edge of the window 120 to partition the predetermined space 125 between the image display device 110 and the window 120, wherein the first transparent substrate 140 on which the first transparent electrode 145 is formed and the second transparent substrate 150 on which the second transparent electrode 155 is formed are provided in the predetermined space 125. The touch panel 100 according to the present invention does not bond the image display device 110 to the second transparent substrate 150 by the adhesive layer unlike the prior art (see FIG. 1) but bonds the image display device 110 to the window 120 by the first adhesive layer 130 so that the predetermined space 125 is partitioned between the image display device 110 and the window 120 and disposes the first transparent substrate 140 on which the first transparent electrode 145 is formed and the second transparent substrate 150 on which the second transparent electrode 155 is formed in the predetermined space 125. Therefore, unlike the prior art, empty space between the second transparent substrate 150 and the image display device 110 is removed, thereby making it possible to prevent Newton's rings from occurring, and the thickness of the first transparent substrate 140 and the second transparent substrate 150 overlaps with the thickness of the first adhesive layer 130, thereby making it possible to make the touch panel 100 thin. Meanwhile, the type of first adhesive layer 130 is not specifically limited but a double adhesive tape (DAT) may be used.

The first transparent substrate 140 and the second transparent substrate 150 serve to provide regions on which the first transparent electrode 145 and the second transparent electrode 155 are formed, respectively. The first transparent substrate 140 and the second transparent substrate 150 are provided in the predetermined space 125 partitioned between the image display device 110 and the window 120. At this time, the first transparent substrate 140 may be fixed in the predetermined space 125 by bonding the other surface of the first transparent substrate 140 (opposite surface of the surface on which the first transparent electrode 145 is formed) to the window 120 by a third adhesive layer 195, and the second transparent substrate 150 may be fixed in the predetermined space 125 by bonding the second transparent substrate 150 to the first transparent substrate 140 by the second adhesive layer 160. Herein, the third adhesive layer 195 may use an optical clear adhesive (OCA), and the second adhesive layer 160 may use a double adhesive tape (DAT). In addition, a side surface 143 of the first transparent substrate 140 and a side surface 153 of the second transparent substrate 150 may be in direct contact with an inner side surface 135 of the first adhesive layer 130 for structural stability of the entire touch panel 100.

Meanwhile, the first transparent substrate 140 and the second transparent substrate 150 should have supporting force capable of supporting the first transparent electrode 145 and the second transparent electrode 155, respectively, and transparency allowing a user to recognize an image provided from the image display device 110. In consideration of the supporting force and the transparency, a material of the first transparent substrate 140 and the second transparent substrate 150 may include polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or tempered glass, and so on, but is not particularly limited thereto. For your reference, it is preferable that the first transparent substrate 140 and the second transparent substrate 150 are subjected to a high frequency treatment or a prime treatment in order to activate one surface of each of them. One surface of each of the first transparent substrate 140 and the second transparent substrate 150 is activated, thereby making it possible to improve adhesion between the transparent substrates (the first transparent substrate 140 and the second transparent substrate 150) and the transparent electrodes (the first transparent electrode 145 and the second transparent electrode 155).

The first transparent electrode 145 and the second transparent electrode 155 generate signals when a user touches the touch panel to allow a controller to recognize touched coordinates based thereon. The first transparent electrode 145 and the second transparent electrode 155 are formed on one surface of the first transparent substrate 140 and one surface of the second transparent substrate 150, respectively. In addition, the edge of the first transparent electrode 145 is bonded to the edge of the second transparent electrode 155 by the second adhesive layer 160, such that the first transparent electrode 145 and the second transparent electrode 155 are disposed to be opposite to each other and the air gap 165 is provided between the first transparent electrode 145 and the second transparent electrode 155. Therefore, when the user touches the touch panel, the first transparent substrate 140 is bent to the second transparent substrate 150 so that the first transparent electrode 145 is in contact with the second transparent electrode 155 through the air gap 165. In this case, the touched coordinates can be recognized by measuring a change in resistance of the first transparent electrode 145 and the second transparent electrode 155. In the touch panel 100 according to the present embodiment, the first transparent electrode 145 and the second transparent electrode 155 are blocked from the outside of the touch panel 100 due to the second adhesive layer 160 and further the first transparent electrode 145 and the second transparent electrode 155 are blocked again from the outside of the touch panel 100 due to the first adhesive layer 130. Therefore, it is possible to prevent moisture or oil from infiltrating into the first transparent electrode 145 and the second transparent electrode 155 and strengthen durability of the touch panel 100.

In addition, the first transparent electrode 145 and the second transparent electrode 155 may be made of a conductive polymer having excellent flexibility and a simple coating process as well as indium tin oxide (ITO) that is commonly used. At this time, the conductive polymer includes poly-3,4-ethylenedioxythiophene/polystyrenesulfonate (PEDOT/PSS), polyaniline, polyacetylene, polyphenylenevinylene, or the like. Meanwhile, the first transparent electrode 145 and the second transparent electrode 155 may be formed by a dry etching process such as sputtering, evaporation or the like, a wet etching process such as dip coating, spin coating, roll coating, spray coating or the like, or a direct patterning process such as screen printing, gravure printing, inkjet printing or the like.

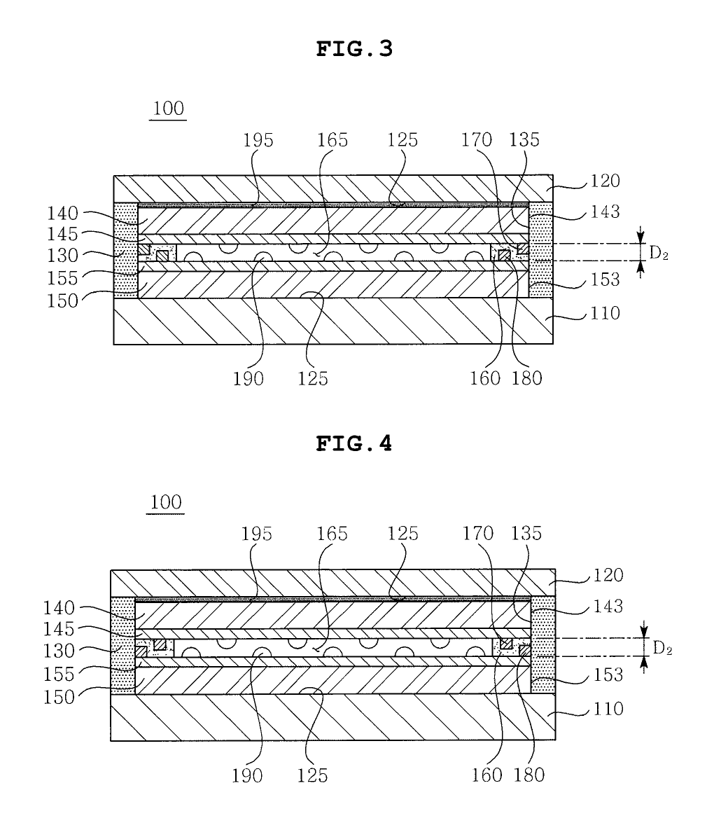

In addition, a first electrode wiring 170 and a second electrode wiring 180 are formed at the edge of the first transparent electrode 145 and the edge of the second transparent electrode 155, respectively. In this configuration, the first electrode wiring 170 and the second electrode wiring 180 serve to receive electrical signals from the first transparent electrode 145 and the second transparent electrode 155, respectively. The electrode wirings may be printed by screen printing, gravure printing, inkjet printing, or the like. Further, the electrode wiring may be made of a material composed of silver (Ag) paste or organic silver having superior electrical conductivity, but the present invention is not limited thereto. In addition, a conductive polymer, carbon black (including CNT), or a low resistive metal including metal or a metal oxide such as ITO may be used. Meanwhile, as shown in FIG. 2, the first electrode wiring 170 and the second electrode wiring 180 may be formed at positions to cross each other as well as at positions to be opposite each other. For example, as shown in FIG. 3, the first electrode wiring 170 may be formed to be closer to the first adhesive layer 130 as compared to the second electrode wiring 180 (the first electrode wiring 170 being formed at the outer side of the second electrode wiring 180). Alternatively, as shown in FIG. 4, the second electrode wiring 180 may be formed to be closer to the first adhesive layer 130 as compared to the first electrode wiring 170 (the second electrode wiring 180 being formed at the outer side of the first electrode wiring 170). As described above, the first electrode wiring 170 and the second electrode wiring 180 are formed to cross each other, thereby making it possible to reduce a thickness between the first transparent electrode 145 and the second transparent electrode 155 (a thickness of the second adhesive layer 160) (D₁→D₂).

In addition, a dot spacer 190 may be provided on the first transparent electrode 145 or the second transparent electrode 155. In this case, the dot spacer 190 relieves the impact between the first transparent electrode 145 and the second transparent electrode 155 when a user touches the touch panel, and provides repulsive force to return the first transparent substrate 140 to its original position when the user's touch is terminated. Therefore, it is preferable that the dot spacer 190 has elasticity and is made of a transparent material so that an image output from the image display device 110 is not blocked by the dot spacer 190. For example, the dot spacer 190 may be formed of an insulating synthetic resin such as an epoxy acrylic resin, or the like. Meanwhile, the dot spacers 190 are provided on both the first transparent electrode 145 and the second transparent electrode 155 in the figures, but this is merely an example. Therefore, the dot spacer 190 may also be provided on only the first transparent electrode 145 or on only the second transparent electrode 155.

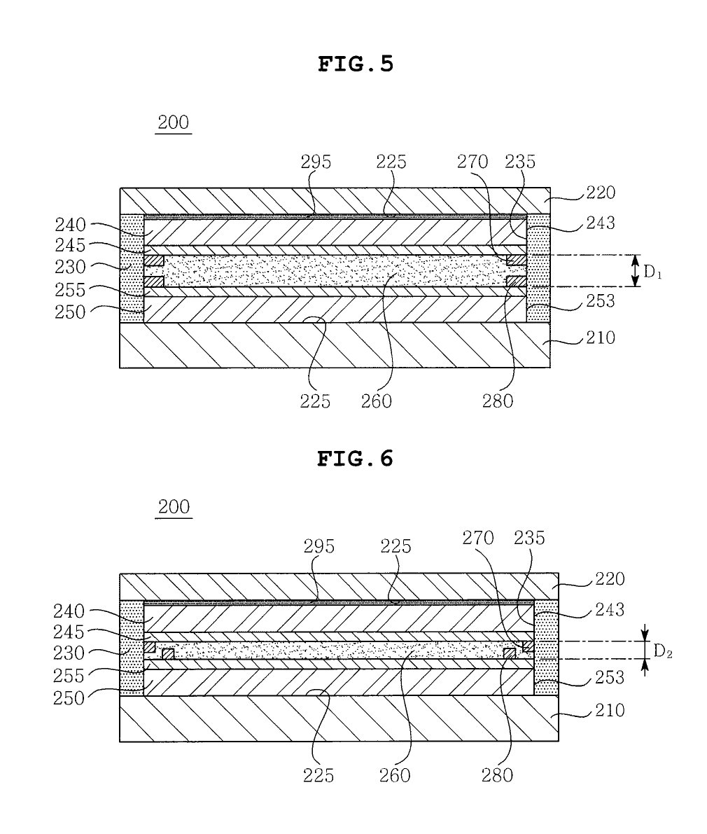

FIGS. 5 to 7 are cross-sectional views of a touch panel according to a second preferred embodiment of the present invention.

Referring to FIGS. 5 to 7, a touch panel 200 according to the present invention includes a first adhesive layer 230 bonding an edge of an image display device 210 to an edge of a window 220 so that a predetermined space 225 is partitioned between the image display device 210 and the window 220; a first transparent substrate 240 provided in the predetermined space 225 and having a first transparent electrode 245 formed on one surface thereof, a second transparent substrate 250 provided in the predetermined space 225 and having a second transparent electrode 255 formed on one surface thereof, and a second adhesive layer 260 bonding the first transparent substrate 240 to the second transparent substrate 250 so that the first transparent electrode 245 is insulated from the second transparent electrode 255, while the first transparent electrode 245 and the second transparent electrode 255 are facing each other.

The greatest difference between the touch panel 100 according to the first embodiment as described above and the touch panel 200 according to the present embodiment is a driving method of the touch panel. In other words, the touch panel 100 according to the first embodiment is a resistive type, whereas the touch panel 200 according to the present embodiment is a capacitive type. Therefore, the present embodiment will be described based on the difference and the description overlapping the first embodiment will be omitted.

The image display device 210 serves to output an image and the window 220 is provided at the outermost portion of the touch panel 200 to protect the touch panel 200. The edge of the image display device 210 is bonded to the edge of the window 220 by the first adhesive layer 230. Therefore, the predetermined space 225 is partitioned between the image display device 210 and the window 220, wherein the first transparent substrate 240 on which the first transparent electrode 245 is formed and the second transparent substrate 250 on which the second transparent electrode 255 is formed are provided in the predetermined space 225. The touch panel 200 according to the present embodiment does not bond the image display device 210 to the second transparent substrate 250 by the adhesive layer unlike the prior art(see FIG. 1) but bonds the image display device 210 to the window 220 by the first adhesive layer 230 so that the predetermined space 225 is partitioned between the image display device 210 and the window 220 and disposes the first transparent substrate 240 on which the first transparent electrode 245 and the second transparent substrate 250 on which the second transparent electrode 255 are formed in the predetermined space 225. Therefore, unlike the prior art, empty space between the second transparent substrate 250 and the image display device 210 is removed, thereby making it possible to prevent Newton's rings from occurring and the thickness of the first transparent substrate 240 and the second transparent substrate 250 overlaps with the thickness of the first adhesive layer 230, thereby making it possible to implement thinness of the touch panel 200. Meanwhile, as the first adhesive layer 230, a double adhesive tape (DAT) may be used.

The first transparent substrate 240 and the second transparent substrate 250 serve to provide regions on which the first transparent electrode 245 and the second transparent electrode 255 are formed, respectively. The first transparent substrate 240 and the second transparent substrate 250 are provided in the predetermined space 225 partitioned between the image display device 210 and the window 220. At this time, the first transparent substrate 240 may be fixed in the predetermined space 225 by bonding the other surface of the first transparent substrate 240 (opposite surface of the surface on which the first transparent electrode 245 is formed) to the window 220 by a third adhesive layer 295, and the second transparent substrate 250 may be fixed in the predetermined space 225 by bonding the second transparent substrate 250 to the first transparent substrate 240 by the second adhesive layer 260. Herein, as the third adhesive layer 295 and the second adhesive layer 260, an optical clear adhesive (OCA) may be used. In addition, it is preferable that the side surface 243 of the first transparent substrate 240 and the side surface 253 of the second transparent substrate 250 are in direct contact with the inner side surface 235 of the first adhesive layer 230 for structural stability of the entire touch panel 200.

The first transparent electrode 245 and the second transparent electrode 255 generate signals when a user touches the touch panel to allow a controller to recognize touched coordinates based thereon. The first transparent electrode 245 and the second transparent electrode 255 are formed on one surface of the first transparent substrate 240 and one surface of the second transparent substrate 250, respectively. In addition, the first transparent electrode 245 is bonded to the second transparent electrode 255 by the second adhesive layer 260, such that the first transparent electrode 245 and the second transparent electrode 255 are disposed to be opposite to each other and the first transparent electrode 245 and the second transparent electrode 255 are insulated from each other. Therefore, when the user touches the touch panel, capacitance of the first transparent electrode 245 and the second transparent electrode 255 is changed and variation in the capacitance is measured, thereby making it possible to recognize the touched coordinates. In the touch panel 200 according to the present embodiment, the first transparent electrode 245 and the second transparent electrode 255 are blocked from the outside of the touch panel 200 due to the second adhesive layer 260 and furthermore, the first transparent electrode 245 and the second transparent electrode 255 are blocked again from the outside of the touch panel 200 due to the first adhesive layer 230. Therefore, it is possible to prevent moisture or oil from infiltrating into the first transparent electrode 245 and the second transparent electrode 255 and strengthen the durability of the touch panel 200.

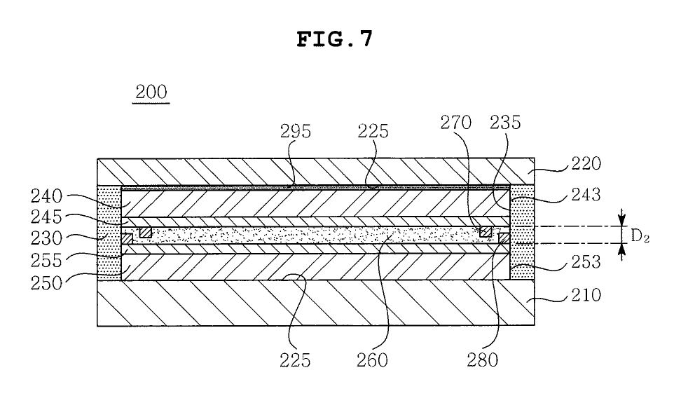

In addition, a first electrode wiring 270 and a second electrode wiring 280 are formed at the edge of the first transparent electrode 245 and at the edge of the second transparent electrode 255, respectively. In this configuration, the first electrode wiring 270 and the second electrode wiring 280 serve to receive electrical signals from the first transparent electrode 245 and the second transparent electrode 255, respectively. The electrode wirings may be printed by screen printing, gravure printing, inkjet printing, or the like. Further, the electrode wiring may be made of a material composed of silver (Ag) paste or organic silver having superior electrical conductivity, but the present invention is not limited thereto. In addition, a conductive polymer, carbon black (including CNT), or a low resistive metal including metal or a metal oxide such as ITO may be used. Meanwhile, as shown in FIG. 5, the first electrode wiring 270 and the second electrode wiring 280 may be formed at positions to cross each other as well as at positions to be opposite each other. For example, as shown in FIG. 6, the first electrode wiring 270 may be formed to be closer to the first adhesive layer 230 as compared to the second electrode wiring 280 (the first electrode wiring 270 being formed at the outer side of the second electrode wiring 280. Alternatively, as shown in FIG. 7, the second electrode wiring 280 may be formed to be closer to the first adhesive layer 230 as compared to the first electrode wiring 270 (the second electrode wiring 280 being formed at the outer side of the first electrode wiring 270). As described above, the first electrode wiring 270 and the second electrode wiring 280 are formed to cross each other, thereby making it possible to reduce a thickness between the first transparent electrode 245 and the second transparent electrode 255 (a thickness of the second adhesive layer 260) (D₁→D₂).

According to the present invention, the image display device is bonded to the window by the adhesive layer so that the predetermined space is partitioned between the image display device and the window and the transparent substrates on which the transparent electrodes are formed in the predetermined space to remove empty space between the transparent substrates and the image display device, thereby making it possible to prevent Newton's rings from occurring and to reduce a thickness, thereby making it possible to implement thinness of the touch panel

In addition, according to the present invention, the outer side of the transparent substrate on which the transparent electrode is formed is surrounded by the adhesive layer to prevent moisture or oil from infiltrating into the transparent electrode, thereby making it possible to strengthen the durability of the touch panel.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claim. Accordingly, such modifications, additions and substitutions should also be understood to fall within the scope of the present invention.

What is claimed is:

1. A touch panel, comprising:
a first adhesive layer bonding an edge of an image display device to an edge of a window so that a predetermined space is partitioned between the image display device and the window;
a first transparent substrate provided in the predetermined space and having a first transparent electrode formed on one surface thereof;
a second transparent substrate provided in the predetermined space and having a second transparent electrode formed on one surface thereof; and
a second adhesive layer bonding an edge of the first transparent electrode to an edge of the second transparent electrode so that the first transparent electrode faces the second transparent electrode and an air gap is provided between the first transparent electrode and the second transparent electrode.

2. The touch panel as set forth in claim 1, further comprising a third adhesive layer bonding the other surface of the first transparent substrate to the window.

3. The touch panel as set forth in claim 1, wherein a side surface of the first transparent substrate and a side surface of the second transparent substrate are in contact with an inner side surface of the first adhesive layer.

4. The touch panel as set forth in claim 1, further comprising:
a first electrode wiring formed at the edge of the first transparent electrode; and
a second electrode wiring formed at the edge of the second transparent electrode.

5. The touch panel as set forth in claim 4, wherein the first electrode wiring is formed to be closer to the first adhesive layer as compared to the second electrode wiring.

6. The touch panel as set forth in claim 4, wherein the second electrode wiring is formed to be closer to the first adhesive layer as compared to the first electrode wiring.

7. The touch panel as set forth in claim 1, wherein dot spacers are provided on the first transparent electrode or the second transparent electrode.

8. The touch panel as set forth in claim 1, wherein the first adhesive layer is a double adhesive tape (DAT).

9. The touch panel as set forth in claim 1, wherein the second adhesive layer is a double adhesive tape (DAT).

10. The touch panel as set forth in claim 2, wherein the third adhesive layer is an optical clear adhesive (OCA).

11. A touch panel, comprising:
a first adhesive layer bonding an edge of an image display device to an edge of a window so that a predetermined space is partitioned between the image display device and the window;
a first transparent substrate provided in the predetermined space and having a first transparent electrode formed on one surface thereof;
a second transparent substrate provided in the predetermined space and having a second transparent electrode formed on one surface thereof; and
a second adhesive layer bonding the first transparent substrate to the second transparent substrate so that the first transparent electrode is insulated from the second transparent electrode, while the first transparent electrode and the second transparent electrode are facing each other.

12. The touch panel as set forth in claim 11, further comprising a third adhesive layer bonding the other surface of the first transparent substrate to the window.

13. The touch panel as set forth in claim 11, wherein a side surface of the first transparent substrate and a side surface of the second transparent substrate are in contact with an inner side surface of the first adhesive layer.

14. The touch panel as set forth in claim 11, further comprising:
a first electrode wiring formed at the edge of the first transparent electrode; and
a second electrode wiring formed at the edge of the second transparent electrode.

15. The touch panel as set forth in claim 14, wherein the first electrode wiring is formed to be closer to the first adhesive layer as compared to the second electrode wiring.

16. The touch panel as set forth in claim 14, wherein the second electrode wiring is formed to be closer to the first adhesive layer as compared to the first electrode wiring.

17. The touch panel as set forth in claim 11, wherein the first adhesive layer is a double adhesive tape (DAT).

18. The touch panel as set forth in claim 11, wherein the second adhesive layer is an optical clear adhesive (OCA).

19. The touch panel as set forth in claim 12, wherein the third adhesive layer is an optical clear adhesive (OCA).
